(19) United States
(12) Patent Application Publication
(10) Pub. No.: US 2021/0084095 A1
(43) Pub. Date: Mar. 18, 2021

(54) Method and Apparatus for Cross Layer Network Diagnostics and Self-Healing Platform for Point-to-Multipoint Networks

(71) Applicant: Bridgewest Ventures LLC, San Diego, CA (US)

(72) Inventor: Saeid Safavi, San Diego, CA (US)

(21) Appl. No.: 17/107,673

(22) Filed: Nov. 30, 2020

Related U.S. Application Data
(62) Division of application No. 16/355,096, filed on Mar. 15, 2019.
(60) Provisional application No. 62/643,892, filed on Mar. 16, 2018.

(51) Int. Cl. H04L 29/06; H04L 12/26

(52) U.S. Cl. CPC H04L 65/80; H04L 43/50; H04L 43/0817; H04L 65/1013

(57) ABSTRACT

A cross layer network diagnostics and self-healing platform for PtMP networks has been described. The disclosed invention utilizes next generation network diagnostics technology to improving broadband services, including, but not limited to, QoS centric applications such as real-time video (e.g. Video Conference Calls, Tele Presence, etc.).

### CROSS-REFERENCE TO RELATED APPLICATIONS—CLAIM OR PRIORITY

The present application is a divisional of, and claims the benefit of priority under 35 USC § 120 of, commonly assigned and co-pending prior U.S. application Ser. No. 16/355,096, filed Mar. 15, 2019, entitled “Method and Apparatus for Cross Layer Network Diagnostics and Self-Healing Platform for Point-to-Multipoint Networks”, the disclosure of which is incorporated herein by reference in its entirety. Application Ser. No. 16/355,096 claims priority to U.S. Provisional Application No. 62/643,892, filed on Mar. 16, 2018, entitled “Method and Apparatus for Cross Layer Network Diagnostics and Self-Healing Platform for Point-to-Multipoint Networks”, which is herein incorporated by reference in its entirety.

### BACKGROUND

### (1) Technical Field

The invention relates to radio frequency telecommunications systems, more particularly cellular network telecommunications systems, and more specifically to methods and apparatuses providing previously unobtainable information that is essential in accurately identifying causes of network related transmission interruptions, faults and failures.

### (2) Background

As a practical matter, the majority of calls handled by network provider customer services centers are caused by malfunctioning wireless or network equipment. Presently, existing diagnostic tools and methods are very limited. In fact, the system capabilities are so limited that systems can only determine whether a connection is established or not. The limits on the present capability mean that currently available diagnostic techniques are incapable of providing any indication whatsoever as to the cause of the network malfunctions. Therefore, a need exists for an improved diagnostics platform that can accurately identify sources of network malfunctions. The disclosed diagnostic methods and apparatus are capable of reducing the volume of customer calls and customer dissatisfaction, improving network performance, reducing customer support costs. These capabilities result in increased profits for the network providers.

### DESCRIPTION OF THE DRAWINGS

FIG. 1 illustrates one embodiment of the disclosed method and apparatus in which the diagnostics engine uses two processes to detect fault conditions.

FIG. 2 is an illustration of the relationship between fault parameters used to determine fault signatures.

Like reference numbers and designations in the various drawings indicate like elements.

### DETAILED DESCRIPTION

The presently disclosed improved diagnostic platform advantageously utilizes evolving trends affecting the transformation of next generation heterogeneous networks. More specifically, the disclosed diagnostic techniques use a cross layer context aware approach to accurately identify network faults. In one disclosed embodiment, the diagnostic platform must be capable of isolating and identifying faults across a wide range of protocols and environments necessitated by the tight integration of wired and wireless networks and their corresponding behavior differences.

In one embodiment, utilizing a cross-layer approach, the disclosed diagnostic platform dynamically monitors network health and proactively detects root causes of network faults. In one embodiment, the invention uses network diagnostics technology for broadband services including Quality of Service (QoS) centric (QoS is a well know term of art described below in more detail) applications such as real-time video (for example, Video Conference Calls, Tele Presence, etc.). The diagnostic technique of the present disclosure is able to achieve this remarkable advancement in network fault detection by capturing the state of network parameters during occurrence of the fault. Heretofore such an inventive technique has not been available.

QoS refers to the capability of a network to provide better service to selected network traffic over various technologies, including Frame Relay, Asynchronous Transfer Mode (ATM), Ethernet and 802.1 networks, SONET, and IP-routed networks that may use any or all of these underlying technologies. The primary goal of QoS is to provide priority including dedicated bandwidth, controlled jitter and latency (required by some real-time and interactive traffic), and improved loss characteristics. Also important is making sure that providing priority for one or more flows does not make other flows fail. QoS technologies provide the elemental building blocks that will be used for future business applications in campus, wide area network (WAN), and service provider networks. This article outlines the features and benefits of the QoS provided by the Cisco Internetwork Operating System (IOS) QoS.

Various wired and wireless network related problems can cause excessive medium access control (MAC) retransmissions, which in turn can severely affect the performance in two ways. First, these layer 2 retransmissions increase overhead and therefore decrease the MAC and application throughput. Second, if application data has to be retransmitted at layer 2, the delivery of application traffic becomes delayed or inconsistent. Advantageously, the presently disclosed diagnostic methods and apparatus monitors the above-described network attributes to precisely identify network faults.

In addition, the disclosed method and apparatus significantly helps with the identification of other problems like software bugs and hardware failures, by ruling out the network problems.

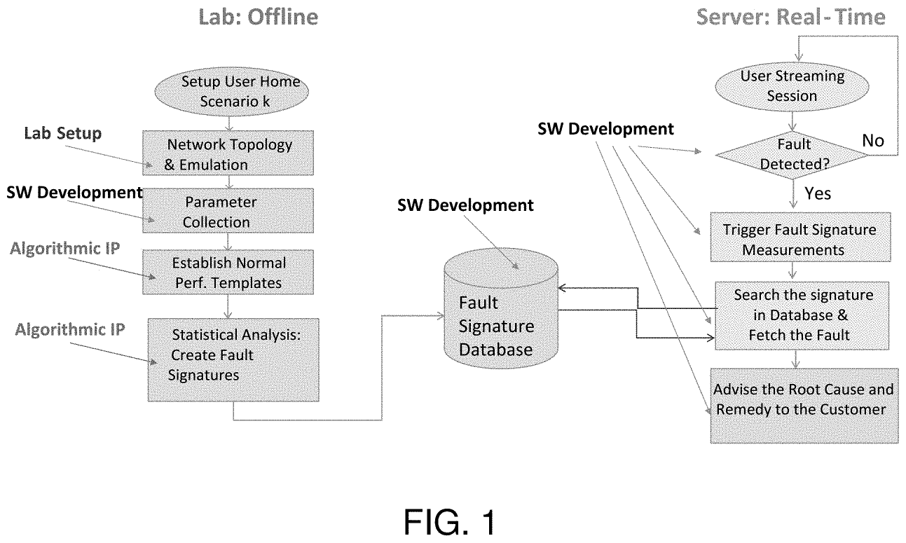

FIG. 1 illustrates one embodiment of the disclosed method and apparatus in which the diagnostics engine uses two processes to detect fault conditions. The first process is an offline, “lab-based” process. In the offline, lab-based process, a “testbed” is used. The testbed is configured for use with a specific user network. In some embodiments, the network includes both the wired and the wireless segments. The wired segment constitutes a specific network topology that is under investigation. This topology may include specific user devices, a network of wireless connections conforming to a particular wireless industry standard, and any wired media (e.g., twisted pair, coaxial cable, etc.) that may be the source of a network fault. The wireless segment is modeled in the emulator by implementing standard channel models. Alternatively, the wireless segment may be modeled using custom channel models that can reproduce a specific point-to-multi-point (PtMP) topology.

The offline process starts by configuring the wired and wireless segments of the network in order to establish performance templates for a fault free or “normal” network. These will include various samples of fault signature tracking parameters. These typically form a vector in a time series. Accordingly, each parameter has values associated with various points in time to establish the “vector in a time series”.

A second process is a real-time or online process. In some embodiments, the online process is continuously run on a centralized diagnostics server (or sever farm). The process starts after signs of an anomaly are detected (e.g., evidence is detected that a potential fault condition exists or is eminent). Such real-time online detection is performed by continuous monitoring higher layer parameters at the application level (such and bandwidth, delay, jitter, etc.). Once a potential anomaly or fault is detected, a next level of granularity in monitoring is started. In this next level of monitoring, a set of parameters used to establish each fault signature is correlated across layers. This is repeated for each fault and the signatures are constantly compared to a baseline, until an exact match (or the best match) is found.

Accordingly, fault diagnostics are provided for PtMP networks, based on fault signature capture. The disclosed method and apparatus can be used as part of network management entity for a PtMP network. A novel cross-layer approach is used to provide fault detection and analysis.

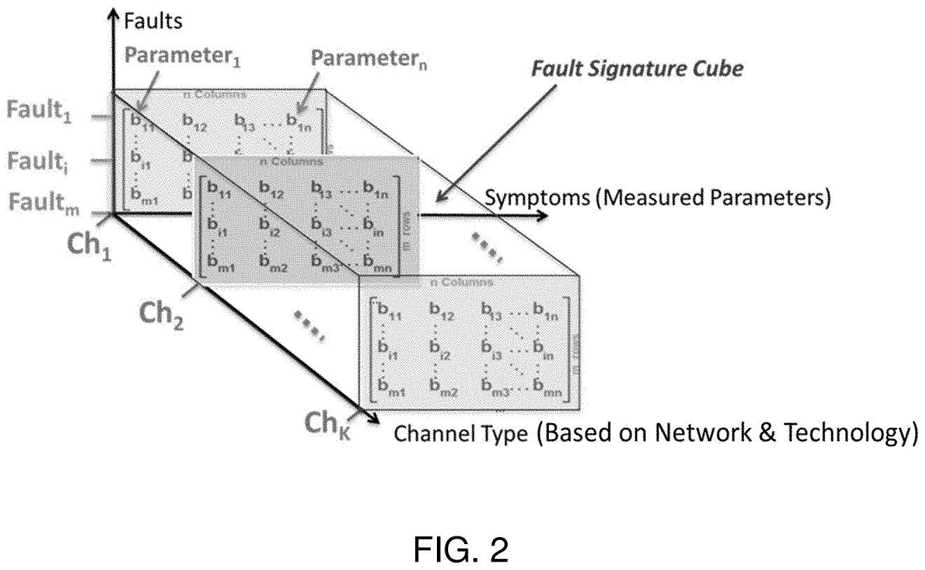

FIG. 2 is an illustration of the relationship between fault parameters used to determine fault signatures.

In addition to the above-described advantages provided by the presently disclosed invention, the novel diagnostic techniques provide the following advantages (the listed advantages are exemplary only and are not to be interpreted as limiting the scope of the invention):
1. A new architecture for fault diagnostics in PtMP mmWave networks collects some RF and network signatures and processes them to find the root cause of a fault or failure
2. A mechanism that employs sufficient visibility into the PHY layer to enable differentiation of the lower layer problems (for example, differentiate between a MAC retransmission caused due to hidden terminals from a retransmission caused due to interference in the network.)
3. A novel performance template for network behavior that evolves with time and adapts itself to changes due to persistent events, while discarding the impact of transient events. This template has to be unique per user, location, network, and RF channel categories.
4. An algorithm that can find the root cause of excessive MAC retransmissions
5. A unique probing mechanism between BS (or access point) and CPEs (or user devices) that can help with detection of root cause of network faults or degradations.
6. A unique approach to fault diagnostics based on network emulation, fault signature captures, statistical analysis and machine learning (ML)
7. Mechanisms for creation and capture of fault signatures, analysis in a testbed and application to the real-world scenarios

### CONCLUSION

A number of embodiments of the disclosed method and apparatus have been described. It is to be understood that various modifications may be made without departing from the spirit and scope of the disclosed method and apparatus. For example, some of the steps described above may be order independent, and thus can be performed in an order different from that described. Further, some of the steps described above may be optional. Various activities described with respect to the methods identified above can be executed in repetitive, serial, or parallel fashion. It is to be understood that the foregoing description is intended to illustrate and not to limit the scope of the any claims that are presented in later filed applications that might claim priority to this disclosure.

What is claimed is:

1. A method for monitoring the operation of a network comprising:
(a) establishing a performance baseline for a plurality of parameters, wherein the plurality of parameters are associated with a plurality of layers within the operating stack of the network and with a plurality of devices across the network:
(b) monitoring a subset of the plurality of parameters in real time; and
(c) determining from the monitored subset of the plurality of parameter that an operational change has occurred that is a significant indication of a degradation in operational performance of the network.

2. The method of claim 1, further comprising, upon determining that an operational change has occurred, increasing the number of parameters that are monitored.

3. The method of claim 1, wherein the determination that an operational change has occurred is made based on a comparison of the data collected from the monitoring of the subset of the plurality of parameters with the established baseline.

4. The method of claim 1, further comprising generating a three-dimensional matrix of data of m rows, n columns and k channels, wherein all (x, n, k) elements of a row x are associated with the one of a plurality of faults that is associated with the row x, all (m, y, k) elements of a column y are each associated with one of the plurality of parameters that is associated with the column y and all elements (m, n, z) of a channel z are associated with a particular channel type that is associated with the channel z, such that each fault can be characterized by a group of symptoms expressed as particular states of each of the plurality of parameters on a row associated with the fault across a plurality of channels on the row associated with the fault.
